(19) United States
(12) Patent Application Publication
(10) Pub. No.: US 2021/0139044 A1
(43) Pub. Date: May 13, 2021

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventor: Atsushi Ishioka, Wako-shi (JP)

(21) Appl. No.: 16/476,571

(22) PCT Filed: Nov. 17, 2017
(86) PCT No.: PCT/JP2017/041495

§ 371 Date: Jul. 9, 2019

(30) Foreign Application Priority Data
Jan. 13, 2017 (JP) 2017-004179

(51) Int. Cl. B60W 60/00; G08G 1/16; B60W 30/18; B60W 40/08; G01C 21/34

(52) U.S. Cl. CPC B60W 60/001; G08G 1/167; B60W 2520/06; B60W 40/08; G01C 21/3453; B60W 30/18163

(57) ABSTRACT

A vehicle control system includes: a recommended lane setter configured to set a recommended lane of a travel schedule in automatic driving; and an automatic driving controller configured to constrain an own vehicle from passing another vehicle when the own vehicle is traveling in the recommended lane set by the recommended lane setter by automatic driving and the recommended lane is a lane of a branching source in a branching spot in front of the own vehicle in a movement direction.

### TECHNICAL FIELD

The present invention relates to a vehicle control system, a vehicle control method, and a vehicle control program.

Priority is claimed on Japanese Patent Application No. 2017-004179, filed Jan. 13, 2017, the content of which is incorporated herein by reference.

### BACKGROUND ART

In the related art, a technology for determining whether to stop or continue changing a lane in accordance with future acceleration of a preceding vehicle which is in front of an own vehicle when the change in the lane associated with passing is performed is known (for example, see Patent Document 1).

### PRIOR ART DOCUMENTS

### Patent Documents

### [Patent Document 1]

Japanese Unexamined Patent Application, First Publication No. 2014-65466

### SUMMARY OF INVENTION

### Problems to be Solved by the Invention

However, in the technology of the related art, for example, a situation occurs in which the own vehicle travels along a lane different from a lane along which the own vehicle originally travels since the change in the lane continues. As a result, the own vehicle may be guided to deviate from a determined route in some cases.

The present invention is devised in view of such circumstances and one object of the present invention is to provide a vehicle control system, a vehicle control method, and a vehicle control program capable of guiding a vehicle to a destination while suppressing unnecessary behavior.

### Solution to Problem

(1) A vehicle control system includes: a recommended lane setter configured to set a recommended lane of a travel schedule in automatic driving; and an automatic driving controller configured to constrain an own vehicle from passing another vehicle when the own vehicle is traveling in the recommended lane set by the recommended lane setter by automatic driving and the recommended lane is a lane of a branching source in a branching spot in front of the own vehicle in a movement direction.

(2) In the vehicle control system according to (1), the automatic driving controller may not perform a change in a lane to return to an original lane when the own vehicle is traveling in the same lane as the recommended lane in a first section located in front of and having a first predetermined distance from the branching spot as a result of the change in the lane performed while the own vehicle passes the other vehicle.

(3) In the vehicle control system according to (1) or (2), the automatic driving controller may permit the own vehicle to pass another vehicle when the own vehicle is traveling in the same lane as the recommended lane in the first section located in front of and having the first predetermined distance from the branching spot as a result of the change in the lane performed while the own vehicle passes the other vehicle in a second section in front of the first section.

(4) The vehicle control system according to any one of (1) to (3) may further include a receiver configured to receive an input operation by an occupant of the own vehicle. The automatic driving controller may have a function of performing the change in the lane in a direction instructed by the occupant based on the input operation performed on the receiver and may stop the function in the first section located in front of and having the first predetermined distance from the branching spot and the second section located in front of the first section.

(5) In the vehicle control system according to any one of (2) to (4), when a lane in front of the branching spot is congested, the automatic driving controller may set a section having the first predetermined distance from an end of the congestion as the first section, the section located in back of and having the first predetermined distance from the end of the congestion.

(6) A vehicle control method is provided for causing an in-vehicle computer to perform: setting a recommended lane of a travel schedule in automatic driving; and constraining an own vehicle from passing another vehicle when the own vehicle is traveling in the set recommended lane by the automatic driving and the recommended lane is a lane of a branching source in a branching spot in front of the own vehicle in a movement direction.

(7) A vehicle control program causes an in-vehicle computer to perform: setting a recommended lane of a travel schedule in automatic driving; and constraining an own vehicle from passing another vehicle when the own vehicle is traveling in the set recommended lane by the automatic driving and the recommended lane is a lane of a branching source in a branching spot in front of the own vehicle in a movement direction.

### Advantageous Effects of Invention

According to (1) to (7), when a recommended lane is a lane of a branching source in a branching spot in front of the own vehicle M in the movement direction, the own vehicle is constrained from passing another vehicle. Therefore, it is possible to guide the vehicle to a destination while suppressing unnecessary behavior.

### BRIEF DESCRIPTION OF THE DRAWINGS

FIG. 1 is a diagram illustrating a configuration of a vehicle control system 1 according to a first embodiment.

FIG. 2 is a diagram illustrating an aspect in which a relative position and an attitude of the own vehicle M with respect to an own lane L1 are recognized by an own vehicle position recognizer 122.

FIG. 3 is a diagram illustrating an aspect in which a target trajectory is generated based on a recommended lane.

FIG. 4 is a flowchart illustrating an example of a process performed by an action plan generator 123.

FIGS. 5A and 5B are a diagram illustrating an example of a scenario in which a passing event is permitted or prohibited.

FIGS. 6A and 6B are a diagram illustrating an example of a scenario in which a change in a lane performed during the passing event is prohibited or permitted.

FIG. 7 is a diagram illustrating an example of a scenario in which a lane-changing event is permitted in a second section.

FIG. 8 is a flowchart illustrating an example of a process when an instruction operation of changing a lane is received by an operation receiver 32.

FIG. 9 is a diagram illustrating an example of a display device 31 on which an event prohibition notification screen is displayed.

FIG. 10 is a diagram illustrating an example of scenario in which a congested vehicle mⱼₐₘ is specified.

FIG. 11 is a diagram illustrating an example of a hardware configuration of an automatic driving controller 100 according to an embodiment.

### EMBODIMENTS FOR CARRYING OUT THE INVENTION

Hereinafter, embodiments of a vehicle control system, a vehicle control method, and a vehicle control program of the present invention will be described with reference to the drawings.

### First Embodiment

FIG. 1 is a diagram illustrating a configuration of a vehicle control system 1 according to a first embodiment. A vehicle in which the vehicle control system 1 is mounted is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle control system 1 includes, for example, a camera 10, a radar device 12, a finder 14, an object recognition device 16, a communication device 20, a human machine interface (HMI) 30, a vehicle sensor 40, a navigation device 50, a micro processing unit (MPU) 60, a driving operator 80, an automatic driving controller 100, a travel driving power output device 200, a brake device 210, and a steering device 220. The devices and units are connected to each other via a multiplex communication line such as a controller area network (CAN) communication line, a serial communication line, or a wireless communication network. The configuration illustrated in FIG. 1 is merely exemplary, some of the constituents may be omitted, and other constituents may be further added.

The camera 10 is, for example, a digital camera that uses a solid-state image sensor such as a charged-coupled device (CCD) or a complementary metal oxide semiconductor (CMOS). The single camera 10 or the plurality of cameras 10 are mounted in any portion of the vehicle in which the vehicle control system 1 is mounted (hereinafter referred to as an own vehicle M). In the case of imaging the area in front of the vehicle, the camera 10 is mounted in an upper portion of a front windshield, a rear surface of a rearview mirror, or the like. For example, the camera 10 repeatedly images near the own vehicle M periodically. The camera 10 may be a stereo camera.

The radar device 12 radiates radio waves such as millimeter waves to the periphery of the own vehicle M and detects radio waves (reflected waves) reflected from an object to detect at least a position (a distance and an azimuth) of the object. The single radar device 12 or the plurality of radar devices 12 are mounted in any portion of the own vehicle M. The radar device 12 may detect a position and a speed of an object in conformity with a frequency-modulated continuous wave (FMCW) scheme.

The finder 14 is a light detection and ranging or a laser imaging detection and ranging (LIDAR) finder that measures scattered light of radiated light and detects a distance to a target. The single finder 14 or the plurality of finders 14 are mounted in any portion of the own vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automatic driving controller 100.

The communication device 20 communicates with other vehicles around the own vehicle M (an example of a nearby vehicle) using, for example, a cellular network, a Wi-Fi network, Bluetooth (registered trademark), dedicated short range communication (DSRC), or the like or communicates with various server devices via wireless base stations.

The HMI 30 suggests various types of information to an occupant of the own vehicle M and receives input operations by the occupant For example, the HMI 30 includes a display device 31 and an operation receiver 32.

The display device 31 is, for example, a liquid crystal display (LCD), an organic electro-luminescence (EL) display device, or the like and is mounted in each unit of an instrument panel or any portion of a front passenger seat or a back seat. The display device 31 is a touch panel with which the operation receiver 32 to be described below is integrated.

The operation receiver 32 receives, for example, an instruction operation to change a lane as one of the operations input by an occupant. The operation receiver 32 is, for example, a control switch of a direction indicator provided near a steering wheel. The operation receiver 32 may be a lever, an input key, or the like. The operation receiver 32 generates an operation input signal based on the received input operation and outputs the operation input signal to the automatic driving controller 100.

The vehicle sensor 40 includes a vehicle speed sensor that detects a speed of the own vehicle M, an acceleration sensor that detects acceleration, a yaw rate sensor that detects an angular velocity around a vertical axis, and an azimuth sensor that detects a direction of the own vehicle M. The vehicle sensor 40 outputs the detected information (a speed, acceleration, an angular velocity, an azimuth, or the like) to the automatic driving controller 100.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver 51 specifies a position of the own vehicle M based on signals received from GNSS satellites. The position of the own vehicle M may be specified or supplemented by an inertial navigation system (INS) using an output of the vehicle sensor 40. The navigation HMI 52 includes a display device, a speaker, a touch panel, and an input key. The navigation HMI 52 may be partially or entirely common to the above-described HMI 30. The route determiner 53 determines, for example, a route from a position of the own vehicle M specified by the GNSS receiver 51 (or any input position) to a destination input by an occupant using the navigation HMI 52 with reference to the first map information 54. The first map information 54 is, for example, information in which a road form is expressed by links indicating roads and nodes connected by the links. The first map information 54 may include curvatures of roads and point of interest (POI) information. The route determined by the route determiner 53 is output to the MPU 60. The navigation device 50 may perform route guidance using the navigation HMI 52 based on the route determined by the route determiner 53. The navigation device 50 may be realized by, for example, a function of a terminal device such as a user's smartphone or a tablet terminal. The navigation device 50 may transmit a current position and a destination to a navigation server via the communication device 20 to acquire a route in a reply from the navigation server.

The MPU 60 functions as, for example, a recommended lane setter 61 and retains second map information 62 in a storage device such as an HDD or a flash memory. The recommended lane setter 61 divides a route provided from the navigation device 50 into a plurality of blocks (for example, divides the route in a vehicle movement direction for each 100 [m]) and sets a recommended lane in which the own vehicle M is to travel for each block with reference to the second map information 62. For example, when a route provided from the navigation device 50 has a plurality of lanes, the recommended lane setter 61 sets any one lane among one or more lanes included in each block as a recommended lane for each block. When there is a branching spot, a joining spot, or the like on the provided route, the recommended lane setter 61 sets a recommended lane so that the own vehicle M can travel along a reasonable travel route for moving to a branching destination on that spot. For example, when a destination is on an extended line branching from a main line including a plurality of lanes, the recommended lane setter 61 sets a lane directed to a lane of a branching destination (branching lane) as a recommended lane among the lanes included in the main lane. More specifically, when there is a necessity of a destination on a branching lane side of a right turn destination from the main lane including a plurality of lanes, the recommended lane setter 61 sets the rightmost lane in the movement direction of the own vehicle M as a recommended lane among the plurality of lanes included in the main lane. When there is a destination on a branching lane side of a left turn destination from the main lane including the plurality of lanes, the recommended lane setter 61 sets the leftmost lane in the movement direction of the own vehicle M as a recommended lane among the plurality of lanes included in the main lane. When no destination is set, for example, the recommended lane setter 61 may set the leftmost lane as a recommended lane among the plurality of lanes included in the main lane.

For example, the recommended lane setter 61 sets a lane (a lane of a branching source) along a branching lane on the main lane in a first section of a first predetermined distance from a starting spot of the branching lane. The starting spot of the branching lane is a spot from which a lane branches from the main lane in front of the own vehicle M in the movement direction. For example, the first predetermined distance is set to the degree of distance (for example, about 2 [km]) that is allowed so that a lane can be changed with a margin until the starting spot of the branching lane. The first section may be a section in which a vehicle arrives when the vehicle travels at a constant speed (for example, an average vehicle speed of a lane) from the starting spot of the branching lane until a first predetermined time passes.

The second map information 62 is map information with higher precision than the first map information 54. The second map information 62 includes, for example, information regarding the middles of lanes or information regarding boundaries of lanes. The second map information 62 may include road information, traffic regulation information, address information (address and zip code), facility information, and telephone number information. The road information includes information indicating kinds of roads such as expressways, toll roads, national ways, or prefecture roads and information such as the number of lanes of a road, the width of each lane, the gradients of roads, the positions of roads (3-dimensional coordinates including longitude, latitude, and height), curvatures of curves of lanes, positions of joining and branching spots of lanes, and signs installed on roads. The second map information 62 may be updated frequently when the communication device 20 are used to access other devices.

The driving operator 80 includes, for example, an accelerator pedal, a brake pedal, a shift lever, and a steering wheel. A sensor that detects whether there is an operation or an operation amount is mounted in the driving operator 80 and a detection result is output to the automatic driving controller 100 or some or all of the travel driving power output device 200, the brake device 210, and the steering device 220.

The automatic driving controller 100 includes, for example, a first controller 120 and a second controller 140. Each of the first controller 120 and the second controller 140 is realized, for example, by causing a processor such as a central processing unit (CPU) to execute a program (software). Some or all of the constituent elements of the first controller 120 and the second controller 140 may be realized by hardware (a circuit unit including circuitry) such as large-scale integration (LSI), an application-specific integrated circuit (ASIC), a field-programmable gate array (FPGA), or a graphics-processing unit (GPU) or may be realized by software and hardware in cooperation.

The first controller 120 includes, for example, an external-world recognizer 121, an own vehicle position recognizer 122, and an action plan generator 123.

The external-world recognizer 121 recognizes states such as positions of nearby vehicles and speeds, acceleration, or the like thereof directly or based on information input from the camera 10, the radar device 12, and the finder 14 via the object recognition device 16. The positions of the nearby vehicles may be represented as representative points such as centers of gravity, corners, or the like of the nearby vehicles or may be represented as regions expressed by contours of the nearby vehicles. The “states” of the nearby vehicles may include acceleration or jerk of the nearby vehicles or “action states” (for example, whether the nearby vehicles are changing their lanes or are attempting to change their lanes). The external-world recognizer 142 may recognize a position of a guardrail, a utility pole, a parked vehicle, a pedestrian, a marking on the surfaces of roads, a sign, and other objects in addition to the nearby vehicle.

The own vehicle position recognizer 122 recognizes, for example, a lane in which the own vehicle M is traveling (an own lane) and a relative position and an attitude of the own vehicle M with respect to the own lane. The own vehicle position recognizer 122 recognizes, for example, the own lane by comparing patterns of road mark lines (for example, arrangement of continuous lines and broken lines) obtained from the second map information 62 with patterns of road mark lines around the own vehicle M recognized from images captured by the camera 10. In this recognition, the position of the own vehicle M acquired from the navigation device 50 or a process result by INS may be added.

Then, the own vehicle position recognizer 122 recognizes, for example, a position or an attitude of the own vehicle M with respect to an own lane. FIG. 2 is a diagram illustrating an aspect in which a relative position and an attitude of an own vehicle M with respect to an own lane L1 are recognized by the own vehicle position recognizer 122. The own vehicle position recognizer 122 recognizes, for example, a deviation OS from an own lane center CL of a reference point (for example, a center of gravity) of the own vehicle M and an angle θ formed with respect to a line drawn with the own lane center CL in the movement direction of the own vehicle M as the relative position and the attitude of the own vehicle M with respect to the own lane L1. Instead of this, the own vehicle position recognizer 122 may recognize a position or the like of the reference point of the own vehicle M with respect to either one side end of the own lane L1 as the relative position of the own vehicle M with respect to the own lane. The relative position of the own vehicle M recognized by the own vehicle position recognizer 122 is supplied to the recommended lane setter 61 and the action plan generator 123.

The action plan generator 123 generates an action plan so that the own vehicle M travels in the lane set as the recommended lane by the recommended lane setter 61 and nearby situations of the own vehicle M can be handled. The action plan includes events which are performed in sequence in automatic driving. The automatic driving refers to control of at least one of steering and an accelerated or decelerated speed of the own vehicle M by the automatic driving controller 100.

The events include, for example, a constant speed traveling event for traveling at a constant speed in the same travel lane, a following travel event for following a preceding vehicle traveling immediately in front of the own vehicle M in the own lane, a lane-changing event for changing a travel lane, and a passing event for passing a preceding vehicle traveling immediately in front of the own vehicle M in the own lane. For example, the passing event is planned under a situation in which a speed of a preceding vehicle is slower by a given speed or more than a speed of the own vehicle M and an average speed or the like of a nearby vehicle traveling in an adjacent lane which is adjacent to the own lane is faster than a speed of the own vehicle M by a given speed or more. For example, when the passing event is performed, the own vehicle M temporarily moves to an adjacent lane by changing the lane and moves to the own lane (the original lane) in front of the preceding and before the change in the lane by changing the lane in accordance with acceleration or the like.

The events include a joining event for accelerating or decelerating the own vehicle M in a joining lane for joining to the main lane to change a traveling lane to the joining lane, a branching event for changing a lane of the own vehicle M to a lane of a branching destination at a branching spot, an emergency stop event for urgently stopping the own vehicle M in accordance with a behavior of a nearby vehicle or the like, and a takeover event for ending automatic driving and switching to manual driving. The manual driving refers to control of the travel driving power output device 200, the brake device 210, and the steering device 220 through an operation on the driving operator 80 by an occupant. While such an event is being performed, an event for avoidance is planned based on a nearby situation (presence of a nearby vehicle or pedestrian, constriction of a lane due to road construction, or the like) of the own vehicle M in some cases.

The action plan generator 123 generates a target trajectory along which the own vehicle M travels in future. The target trajectory includes, for example, a speed component. For example, the target trajectory is generated as a set of target spots (trajectory points) at which a vehicle arrives at a plurality of future reference times set for each predetermined sampling time (for example, about tenths of a second). Therefore, when an interval between trajectory points is large, it is assumed that the vehicle travels a section between the trajectory points at a high speed.

FIG. 3 is a diagram illustrating an aspect in which a target trajectory is generated based on a recommended lane. As illustrated, the recommended lane is set so that it is convenient to travel along a route to a destination. When the vehicle arrives within a predetermined distance in front of a switching spot of the recommended lane (which may be determined in accordance with a type of event), the action plan generator 123 activates a lane-changing event, a branching event, a joining event, or the like. When it is necessary to avoid an obstacle during execution (activation) of each event, the action plan generator 123 may generate a trajectory for avoidance or may generate a trajectory for deceleration to stop the own vehicle M in front of an obstacle, as illustrated.

For example, the action plan generator 123 generates a plurality of candidates for the target trajectory and selects an optimum target trajectory at that time based on the perspective of safety and efficiency.

When the position of the own vehicle M is within a second section in front of the first section, the action plan generator 123 constrains the own vehicle M from passing a preceding vehicle. The second section is a section located in front of and having a second predetermined distance from the first section. The second predetermined distance may be, for example, a distance which is substantially the same as the first predetermined distance or may be a distance shorter or longer than the first predetermined distance. The second section may be a section in which a vehicle arrives when the vehicle travels at a constant speed (for example, an average vehicle speed of a lane) from the first section until a second predetermined time passes.

For example, when a passing event is planned in the second section, the action plan generator 123 prohibits the passing event by not generating a target trajectory for the passing when the own vehicle M arrives at the second section.

The second controller 140 includes a travel controller 141. The travel controller 141 controls the travel driving power output device 200, the brake device 210, and the steering device 220 so that the own vehicle M passes through the target trajectory generated by the action plan generator 123 at a scheduled time.

The travel driving power output device 200 outputs travel driving power (torque) for traveling the vehicle to a driving wheel. The travel driving power output device 200 includes, for example, a combination of an internal combustion engine, an electric motor and a transmission, and an electronic controller (ECU) controlling these units. The ECU controls the foregoing configuration in accordance with information input from the travel controller 141 or information input from the driving operator 80.

The brake device 210 includes, for example, a brake caliper, a cylinder that transmits a hydraulic pressure to the brake caliper, an electronic motor that generates a hydraulic pressure in the cylinder, and a brake ECU. The brake ECU controls the electric motor in accordance with information input from the travel controller 141 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the travel controller 141 such that a hydraulic pressure of the master cylinder is transmitted to the cylinder.

The steering device 220 includes, for example, a steering ECU and an electric motor. The electric motor applies a force to, for example, a rack and pinion mechanism to change a direction of a steering wheel. The steering ECU drives the electric motor to change the direction of the steering wheel in accordance with information input from the travel controller 141 or information input from the driving operator 80.

Hereinafter, a series of processes by the action plan generator 123 will be described with reference to the flowchart. FIG. 4 is a flowchart illustrating an example of a process performed by the action plan generator 123. For example, the process of the flowchart is repeatedly performed at a predetermined period during automatic driving.

First, the action plan generator 123 determines in which section the position of the own vehicle M is located based on a relative positional relationship between a position of the own vehicle M specified using some or all of the own vehicle position recognizer 122, the navigation device 50, and the INS and a recommended lane set by the recommended lane setter 61 (step S100).

For example, when the position of the own vehicle M is located in the first section, the action plan generator 123 prohibits the passing event (step S102) and ends the process of the flowchart.

When the position of the own vehicle M is located in the second section, the action plan generator 123 prohibits the passing event in principle (step S104). When a certain condition is satisfied, the action plan generator 123 may permit a change in the lane in the passing event. The condition will be described later.

When the position of the own vehicle M is located in another section different from the first and second sections, the action plan generator 123 permits the passing event (step S106).

FIGS. 5A and 5B are a diagram illustrating an example of a scenario in which a passing event is permitted or prohibited. In the drawing, m_{ref} indicates a preceding vehicle. When the own vehicle M is located in a section in front of the second section as in 5A of the drawing, a passing event associated with a change in a lane from the own lane L1 to an adjacent lane L2 is permitted. When the own vehicle M is located in the second section as in 5B of the drawing, the passing event is prohibited. For example, a branching event is planned in the first section after the second section. Therefore, when the own vehicle M is caused to change its lane for passing, it is assumed that the own vehicle M may not return to the original lane L1 and pass by a branching spot. Therefore, when the lane in which the own vehicle M is traveling in the second section is the lane L1 set as a recommended lane in the first section, the action plan generator 123 prohibits the passing event and preferentially maintains the current lane. Thus, it is possible to guide the own vehicle M to a destination while suppressing unnecessary behavior. Accordingly, it is possible to improve precision of guiding to the destination.

Subsequently, when a passing event associated with a change in the lane is performed in a section in front of the second section, the action plan generator 123 determines whether a lane of a lane changing destination (a lane of a branching source) is the same as a line set as a recommended lane in the first section (step S108). That is, the action plan generator 123 determines whether the own vehicle M is traveling in the same lane as the recommended lane in the first section as a result of the change in the lane performed while the own vehicle M passes a preceding vehicle.

When the lane of the lane changing destination is different from the lane set as the recommended lane (the lane of the branching source) in the first section, that is, the own vehicle M is traveling in a lane different from the recommended lane in the first section by the change in the lane in the passing event, the action plan generator 123 prohibits the travel controller 141 from changing the lane from the lane of the lane changing destination to the lane before the change in the lane after the second section (step S110).

Conversely, when the lane of the lane changing destination is the same as the lane set as the recommended lane (the lane of the branching source) in the first section, that is, the own vehicle M is traveling in the same lane as the recommended lane in the first section by the change in the lane in the passing event, the action plan generator 123 permits the travel controller 141 to change the lane from the lane of the lane changing destination to the lane before the change in the lane after the second section (step S112).

FIGS. 6A and 6B are a diagram illustrating an example of a scenario in which a change in a lane performed during the passing event is prohibited or permitted. An example of 6A of the drawing shows permission to pass a preceding vehicle m_{ref} in association with the change in the lane from the lane L2 to the lane L1 at time tᵢ. At this time, when a recommended lane in the first section is set to the lane L1, as illustrated, return to the original lane L2 by the change in the lane is prohibited at time at which the change in the lane to the lane L1 is completed. Thus, an unnecessary change in the lane is suppressed.

Conversely, an example of 6B of the drawing shows permission to pass the preceding vehicle m_{ref} in association with the change in the lane from the lane L1 to the lane L2 at time tᵢ. At this time, when the recommended lane in the first section is set to the lane L1, as illustrated, return to the original lane L2 by the change in the lane is permitted at time at which the change in the lane to the lane L2 is completed.

As described above in the embodiment, the action plan generator 123 prohibits the change in the lane when the position of the own vehicle M is within the second section, but the present invention is not limited thereto. For example, when a condition that the lane of the lane changing destination is a recommended lane in the first section is satisfied, the action plan generator 123 may permit the change in the lane in the second section despite the position of the own vehicle M which is within the second section.

FIG. 7 is a diagram illustrating an example of a scenario in which a lane-changing event is permitted in the second section. In a lane-changing event for a mere movement to an adjacent lane, as illustrated, the action plan generator 123 may permit the movement. That is, when a timing of a lane-changing event (which is a component of a branching event) planned in the first section after the second section is merely advanced, the action plan generator 123 may permit the change in the lane.

According to the above-described first embodiment, by including the recommended lane setter 61 configured to set a recommended lane of a travel schedule in automatic driving; and the action plan generator 123 configured to constrain the own vehicle M from passing a preceding vehicle when the own vehicle M is traveling in the recommended lane set by the recommended lane setter 61 by automatic driving and the recommended lane is a lane of a branching source in a branching spot in front of the own vehicle M in a movement direction, it is possible to guide the vehicle to a destination while suppressing unnecessary behavior.

### Second Embodiment

Hereinafter, a second embodiment will be described. The second embodiment is different from the above-described first embodiment in that a change in a lane in a direction instructed by an occupant is performed in accordance with an instruction operation of changing the lane which is received by the operation receiver 32. Hereinafter, differences from the first embodiment will be mainly described and functions or the like common to the first embodiment will be omitted.

In the second embodiment, when an instruction operation of changing the lane is performed in the operation receiver 32, the travel controller 141 controls the travel driving power output device 200, the brake device 210, and the steering device 220 without being associated with an event planned in advance as an action plan such that the lane for the own vehicle M is changed in the direction instructed by an occupant. For example, when the control switch of the direction indicator is operated to turn on the right turn indicator, the travel controller 141 changes the lane for the own vehicle M to a lane on the side of the right turn indicator, that is, the lane on the right side in the travel movement direction.

FIG. 8 is a flowchart illustrating an example of a process when an instruction operation of changing a lane is received by the operation receiver 32. In the second embodiment, the action plan generator 123 first determines whether an instruction operation of changing a lane is performed in the operation receiver 32 in the first section with reference to an operation input signal output by the operation receiver 32 (step S200). When the instruction operation of changing the lane is not performed in the operation receiver 32, the process of the flowchart ends.

Conversely, when the instruction operation of changing the lane is performed in the operation receiver 32, the action plan generator 123 causes the display device 31 to display an event prohibition report screen (step S202) and invalidates the control in accordance with the instruction operation of changing the lane. Thus, the change in the lane scheduled to be performed by the travel controller 141 in accordance with the instruction operation of changing the lane is stopped.

FIG. 9 is a diagram illustrating an example of a display device 31 on which an event prohibition notification screen is displayed. As illustrated, the display device 31 displays, as the event report screen, a screen indicating that a section in which the own vehicle M is currently traveling is a section in which the change in the lane is prohibited.

Subsequently, the action plan generator 123 determines again whether an instruction operation of changing the lane is performed in the operation receiver 32 with reference to an operation input signal output by the operation receiver 32 (step S204).

When the instruction operation of changing the lane is performed in the operation receiver 32, that is, an occupant performs the instruction operation of changing the lane again in a state in which a lane-changing event is prohibited, the action plan generator 123 determines that the occupant requests manual driving, changes the currently performed event to a handover event (step S206), ends the automatic driving, and switches the automatic driving to the manual driving. Instead of changing the currently performed event to the handover event, the action plan generator 123 may change the event to, for example, a constant speed traveling event or a following travel event. In this case, it is assumed that the own vehicle M may not be guided to a lane of a branching destination which is a destination direction.

According to the above-described second embodiment, it is possible to guide the vehicle to the destination while suppressing unnecessary behavior as in the above-described first embodiment.

According to the above-described second embodiment, it is possible to perform automatic driving more flexibly.

### Third Embodiment

Hereinafter, a third embodiment will be described. In the above-described first and second embodiments, the first section is set using a branching spot as a reference. The third embodiment is different from the above-described embodiments in that the position of the first section is changed in accordance with the degree of congestion on a lane along a branching lane in one lane or a plurality of lanes included in a main lane. Hereinafter, differences from the first and second embodiments will be mainly described and functions or the like common to the first and second embodiments will be omitted.

In the third embodiment, for example, the communication device 20 may communicate with an external server device that monitors a traffic situation such as congestion or a traffic accident and may acquire information indicating the traffic situation.

In the third embodiment, the action plan generator 123 specifies congested vehicles mⱼₐₘ including a plurality of vehicles based on the information indicating the traffic situation acquired by the communication device 20 or a surrounding vehicle state recognized by the external-world recognizer 121. Then, the action plan generator 123 sets a section located in front of and having the first predetermined distance or a first predetermined time from the position of a rearmost vehicle mega among the congested vehicle mⱼₐₘ, as the first section.

FIG. 10 is a diagram illustrating an example of a scenario in which a congested vehicle mⱼₐₘ is specified. When there is the congested vehicle mⱼₐₘ on the lane L1 connected to a lane L3 of the branching destination, as illustrated, the action plan generator 123 sets the first section using the position of the rearmost vehicle m_{end} as a reference among the congested vehicles mⱼₐₘ. Thus, the lane can be appropriately changed in accordance with an actual traffic situation.

### [Hardware Configuration]

The automatic driving controller 100 of the vehicle control system 1 according to the above-described embodiments is realized with, for example, a hardware configuration illustrated in FIG. 11. FIG. 11 is a diagram illustrating an example of the hardware configuration of the automatic driving controller 100 according to an embodiment.

The automatic driving controller 100 has a configuration in which, for example, a communication controller 100-1, a CPU 100-2, a RAM 100-3, a ROM 100-4, a secondary storage device 100-5 such as a flash memory or an HDD, and a drive device 100-6 are connected to each other via an internal bus or a dedicated communication line. A portable storage medium such as an optical disc is mounted in the drive device 100-6. A program 100-5a stored in the secondary storage device 100-5 is loaded on the RAM 100-3 by a DMA controller (not illustrated) or the like and is executed by the CPU 100-2, so that each functional unit (the first controller 120 and the second controller 140) of the automatic driving controller 100 is realized. A program referred to by the CPU 100-2 may be stored in a portable storage medium mounted in the drive device 100-6 or may be downloaded from another device via a network NW.

The foregoing embodiments can be expressed as follows.

A vehicle control system including a storage that stores information and a processor that executes a program stored in the storage are included. The processor executes the program to set a recommended lane of a travel schedule in automatic driving and to constrain an own vehicle from passing another vehicle when the own vehicle is traveling in the set recommended lane by the automatic driving and the recommended lane is a lane of a branching source in a branching spot in front of the own vehicle in a movement direction.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### DESCRIPTION OF REFERENCE NUMERALS

1 Vehicle control system
10 Camera
12 Radar device
14 Finder
16 Object recognition device
20 Communication device
30 HMI
31 Display device
32 Operation receiver
40 Vehicle sensor
50 Navigation device
51 GNSS receiver
52 Navigation HMI
53 Route determiner
54 First map information
60 MPU
61 Recommended lane setter
62 Second map information
80 Driving operator
100 Automatic driving controller
120 First controller
121 External-world recognizer
122 Own vehicle position recognizer
123 Action plan generator
140 Second controller
141 Travel controller
200 Travel driving force output device
210 Brake device
210 Steering device

1. A vehicle control system, comprising:
a recommended lane setter configured to set a recommended lane of a travel schedule in automatic driving; and
an automatic driving controller configured to constrain an own vehicle from passing another vehicle when the own vehicle is traveling in the recommended lane set by the recommended lane setter by automatic driving and the recommended lane is a lane of a branching source in a branching spot in front of the own vehicle in a movement direction.

2. The vehicle control system according to claim 1, wherein the automatic driving controller does not perform a change in a lane to return to an original lane when the own vehicle is traveling in the same lane as the recommended lane in a first section located in front of and having a first predetermined distance from the branching spot as a result of the change in the lane performed while the own vehicle passes the other vehicle.

3. The vehicle control system according to claim 1 or 2, wherein the automatic driving controller permits the own vehicle to pass another vehicle when the own vehicle is traveling in the same lane as the recommended lane in the first section located in front of and having the first predetermined distance from the branching spot as a result of the change in the lane performed while the own vehicle passes the other vehicle in a second section in front of the first section.

4. The vehicle control system according to claim 1, further comprising:
a receiver configured to receive an input operation by an occupant of the own vehicle,
wherein the automatic driving controller has a function of performing the change in the lane in a direction instructed by the occupant based on the input operation performed on the receiver and stops the function in the first section located in front of and having the first predetermined distance from the branching spot and the second section located in front of the first section.

5. The vehicle control system according to claim 2, wherein, when a lane in front of the branching spot is congested, the automatic driving controller sets a section from an end of the congestion in a direction toward the own vehicle as the first section, the section located in back of and having the first predetermined distance from the end of the congestion.

6. A vehicle control method for causing an in-vehicle computer to perform:
setting a recommended lane of a travel schedule in automatic driving; and
constraining an own vehicle from passing another vehicle when the own vehicle is traveling in the set recommended lane by the automatic driving and the recommended lane is a lane of a branching source in a branching spot in front of the own vehicle in a movement direction.

7. A computer-readable non-transitory storage medium storing a vehicle control program causing an in-vehicle computer to perform:
setting a recommended lane of a travel schedule in automatic driving; and
constraining an own vehicle from passing another vehicle when the own vehicle is traveling in the set recommended lane by the automatic driving and the recommended lane is a lane of a branching source in a branching spot in front of the own vehicle in a movement direction.
